(19) United States
(12) Patent Application Publication
(10) Pub. No.: US 2026/0028219 A1
(43) Pub. Date: Jan. 29, 2026

(54) GIRTHS

(71) Applicants: David Kempsell, Kingston, Canterbury Kent (GB); Margaret Lesley White, Kingston, Canterbury Kent (GB)

(72) Inventors: David Kempsell, Kingston, Canterbury Kent (GB); Margaret Lesley White, Kingston, Canterbury Kent (GB)

(21) Appl. No.: 18/854,529

(22) PCT Filed: Apr. 5, 2023
(86) PCT No.: PCT/EP2023/059069

§ 371 Date: Oct. 5, 2024

(30) Foreign Application Priority Data
Apr. 5, 2022 (GB) 2205010.8

(51) Int. Cl. B68C 1/14; B32B 3/26; B32B 5/18; B32B 9/02; B32B 9/04; B32B 27/06

(52) U.S. Cl. CPC B68C 1/14; B32B 3/266; B32B 5/18; B32B 9/025; B32B 9/045; B32B 9/046; B32B 27/065; B32B 2260/021; B32B 2260/046; B32B 2262/106; B32B 2266/02; B32B 2266/08; B32B 2307/72; B32B 2307/7376

(57) ABSTRACT

The present invention relates to girths. More particularly, the present invention relates to improvements in the area of the girth around the sternum of a horse and the mobility of muscles of the horse under a girth adjacent to the sternum. We describe a girth comprising girth straps (64) and a sternum plate (40) spacing and bridging the girth straps (64) such that, in use on a horse, the girth straps are substantially prevented by the sternum plate from contacting the horse in the region of the ascending pectoral (21) and rectus abdominus (31) muscles of the horse. The sternum plate (40) comprises a girth plate (41) formed of a material which will not substantially flex or deform under pressures exerted by the girth straps when tightened, in use, on a horse.

The present invention relates to girths. More particularly, the present invention relates to improvements in the area of the girth around the sternum of a horse and the mobility of muscles of the horse under a girth adjacent to the sternum.

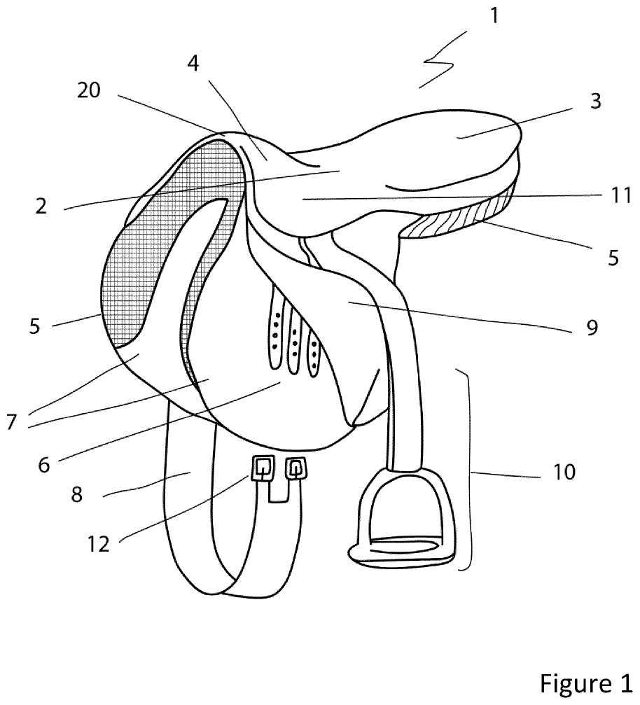

A typical girth 8 for a horse is shown in FIG. 1. The girth passes under the horse's rib cage behind the elbows of horse in the area called “the girth groove”. The girth groove is the place the horse will carry the girth, and this will not be the same on every horse. It will alter with conformation and fitness of the horse. The girth's purpose is to secure and hold a Saddle 1 in place. To do this it must pass around the lower half of the rib cage laying across the sternum of the horse's rib cage like a belt. The girth 8 is attached to the saddle 1 by means of straps on the saddle called girth billets 6 normally 1″ (25 mm) in width and 3/16″ (4-5 mm) thick to buckles 12 on the girth 8. The girth billets 6 have holes for the buckles 12 nominally ¼″ (30 mm) apart to facilitate the girth fitting differing circumferences of horse's rib cage.

Typically, girths are made of leather or synthetic materials that share the characteristic of being able to mould themselves around the horse's rib cage as the girth is tightened using the girth billets 6 and buckles 12.

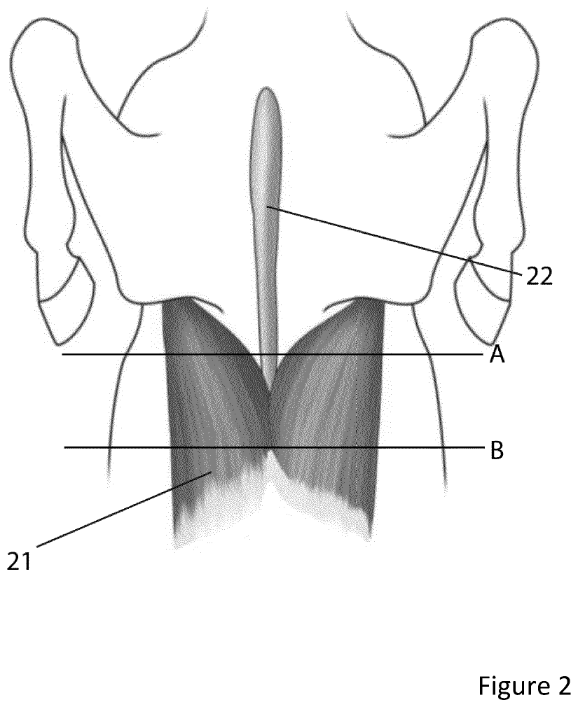

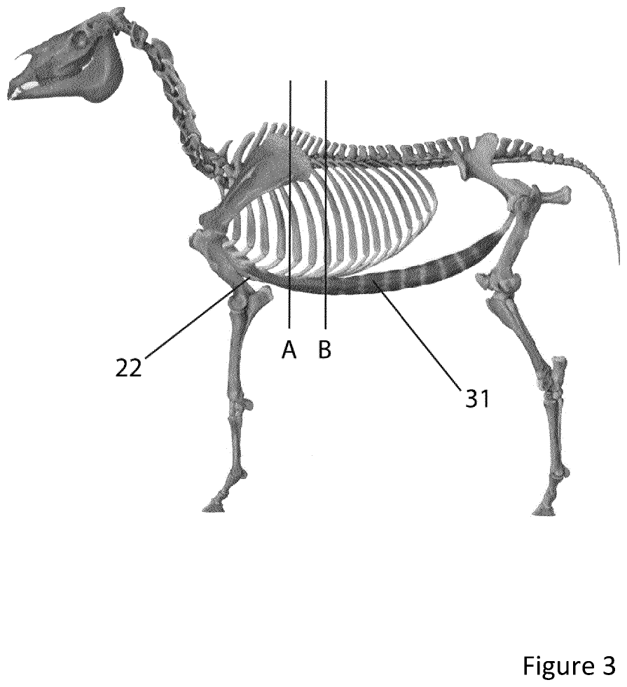

It is commonly accepted that girths touch, and therefore apply pressure to, the horse for the entirety of the girth's length. With reference to FIG. 2 showing the view of the underside of a horse and FIG. 3 the side view of a skeleton of a horse, this band of pressure will lay across the muscles adjacent to the sternum 22 of the horse, between lines A & B as drawn, in particular, across the ascending pectoral 21 muscle and the rectus abdominus 31 muscle which lies under this ascending pectoral 21.

The ascending pectoral 21 is responsible for suspension of the trunk (rig cage) between the thoracic limbs, forelimb retraction and stabilisation of the glenohumeral joint; and reinforces the action of the latissimus dorsi which retracts the forelimb.

The rectus abdominus 31 muscle connects the thorax to the pelvis and is responsible for support of the abdominal viscera, aids in defecation and parturition, aids in expiration and, most importantly for the ridden horse, flexes or lifts the back.

Therefore, a girth that applies pressure to these muscle groups will impede the function of the muscles and therefore the functional mobility of the horse. Pressure applied to the muscles will depend on the tightness of the girth but the looser the girth the less stable the saddle and thus the rider will be which ultimately ends up that the girth is tightened to a point at which the rider feels stable/safe. Pressure on the musculature impedes the ability of the horse to move to its best potential.

Some manufacturers produce girths with a short piece of elastic between the Buckle 12 and the main body or Strap 8 of the girth. This is meant to afford some comfort to the horse but in practice has been shown to exacerbate movement in the saddle which in turn rubs the horse. In short, this practice has not found favour with a lot of saddle fitters.

The present invention aims to overcome these problems.

In its broadest sense, the present invention provides a girth which has a sternum plate which will bridge the girth straps so they do not touch the pectoral muscle groups of the horse by use of a resilient material in the area of the sternum. The sternum plate also provides a means for the horse to expand and contract its rib cage without the use of elastic materials in the straps of the girth.

More specifically, the present invention provides a girth for a horse, the girth comprising girth straps and a sternum plate spacing and bridging the girth straps such that, in use on a horse, the girth straps are substantially prevented by the sternum plate from contacting the horse in the region of the ascending pectoral and rectus abdominus muscles of the horse, wherein the sternum plate comprises a girth plate formed of a material which will not substantially flex or deform under pressures exerted by the girth straps when tightened, in use, on a horse.

Preferably, the girth plate does not deflect, flex or deform when a force of about 20 Nm is applied to the girth straps perpendicular to a surface of the girth plate.

Preferably, the girth plate is formed of a polymeric material or formable material like carbon fibre reinforced plastics materials.

Preferably, the girth plate is shield like shape to follow the shape of the animal's rib cage as the circumference enlarges moving backwards from line A to line B (FIGS. 2 & 3).

More specifically, the present invention provides a girth comprising girth straps and a sternum plate spacing and bridging the girth straps such that, in use on a horse, they do not touch the pectoral muscle groups of the horse, wherein the sternum plate comprises a resilient material in the area of the sternum.

In certain embodiments, the sternum plate comprises a resilient plate and a sternum pad, wherein the sternum pad is proximal to the horse, in use.

Suitably, the resilient plate is formed of a polymeric material or a formable material such as carbon fibre.

Advantageously, the resilient plate is formed of polypropylene having a thickness of from 3 mm to 8 mm, from 4 mm to 6 mm or about 5 mm.

In some examples, the resilient plate includes stiffening ribs, optionally lateral stiffening ribs.

Preferably, the sternum plate further comprises a proximal layer of foam padding, optionally a layer of foam padding having a thickness of from 5 mm to 18 mm, 8 mm to 14 mm, 9 mm to 12 mm or about 10 mm and optionally formed of a closed-cell foam.

In certain examples, the sternum plate includes an upper cover and a lower cover, optionally wherein the upper and/or lower covers are formed of leather or a similarly-performing material.

Optionally, at least one of the upper and/or lower covers includes perforations to permit air flow between the inside and outside of the sternum plate.

In certain embodiments, an upper surface of the sternum plate includes guides or keepers to position the girth straps to prevent longitudinal movement with respect to the sternum plate.

Optionally, the sternum pad is formed of a foamed polymeric material, optionally a closed-cell foam.

Optionally, the foam has a thickness of from 15 mm to 40 mm, 20 mm to 30 mm, or about 25 mm.

In some examples, the sternum pad further comprises an upper cover and a lower cover, optionally wherein the upper and/or lower covers are formed of leather or a similarly-performing material.

Optionally, at least one of the upper and/or lower covers includes perforations to permit air flow between the inside and outside of the sternum pad.

In embodiments including foam, advantageously the foam has a net density of 80-150 kg/m³, or 100-120 kg/m³ and/or the foam has a compression resistance of 9 to 25 kPa, 11 to 24 kPa

Advantageously, the sternum plate is shaped to follow the shape of the horse's rib cage as the circumference enlarges moving backwards from line A to line B as shown in FIGS. 2 and 3.

By the term “substantially prevented by the sternum plate from contacting the horse in the region of the ascending pectoral and rectus abdominus muscles of the horse”, it is intended that, in preferred embodiments, the girth straps make no contact with the horse overlying the location of the ascending pectoral and rectus abdominus muscles. In alternative embodiments, the sternum plate may contact the horse in the region of the ascending pectoral and rectus abdominus muscles by an amount sufficiently small as to not impede contraction of the muscles to an extent which impedes movement of the horse. In such embodiments, preferably the sternum plate contacts no more than 20% of the skin of the horse in the area of the muscles, no more than 15%, no more than 10% or no more than 5% of the muscle area. In preferred examples of these embodiments, the sternum plate may contact the skin of the horse only in peripheral areas of the ascending pectoral and rectus abdominus muscles.

The above and other aspects of the present invention will now be described in further detail, by way of example only, with reference to the accompanying figures, in which:

FIG. 1 is an explanatory view of a horse with saddle and girth;

FIG. 2 is the view of the underside of a horse's rib cage;

FIG. 3 is view of a horse's skeleton from the side;

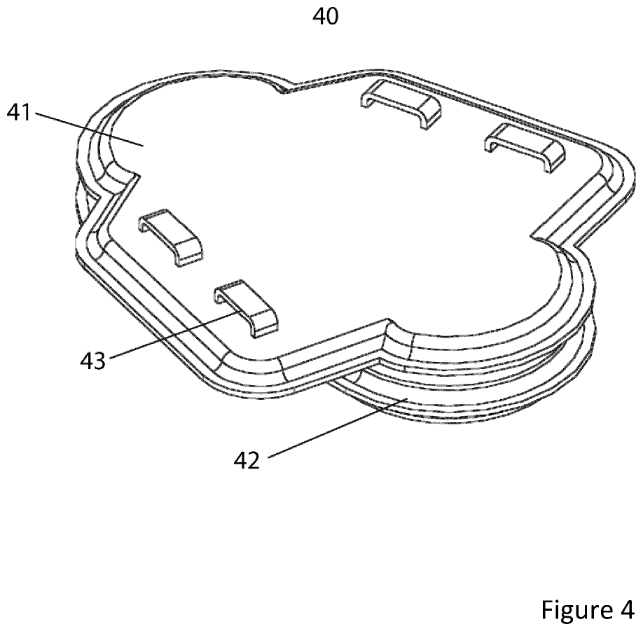

FIG. 4 is view of an embodiment of girth of the present invention with girth straps omitted;

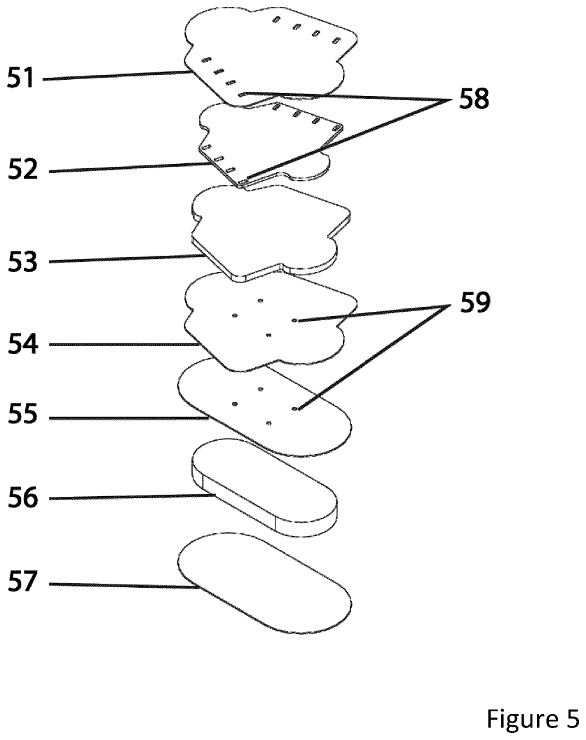

FIG. 5 is a perspective view of the embodiment of FIG. 4 in a disassembled or exploded configuration;

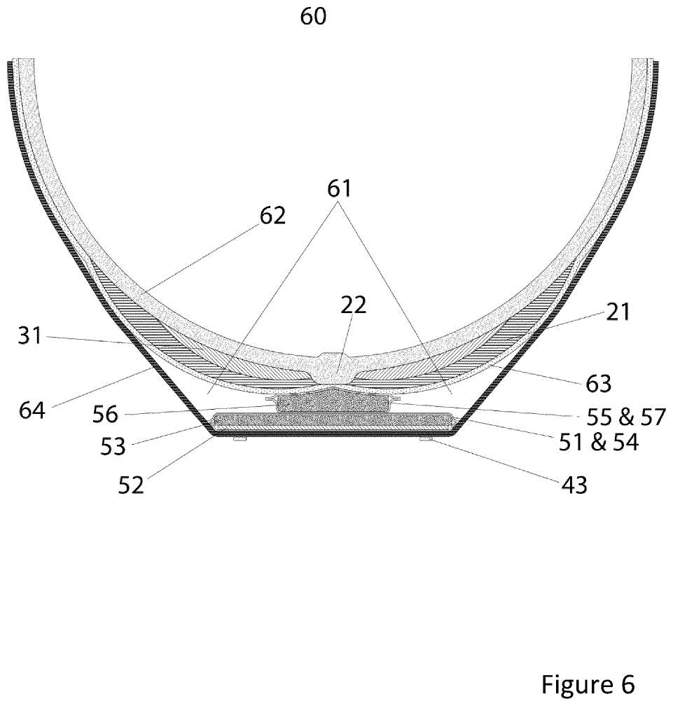

FIG. 6 is a cross sectional view of the embodiment of FIG. 4 secured to a horse;

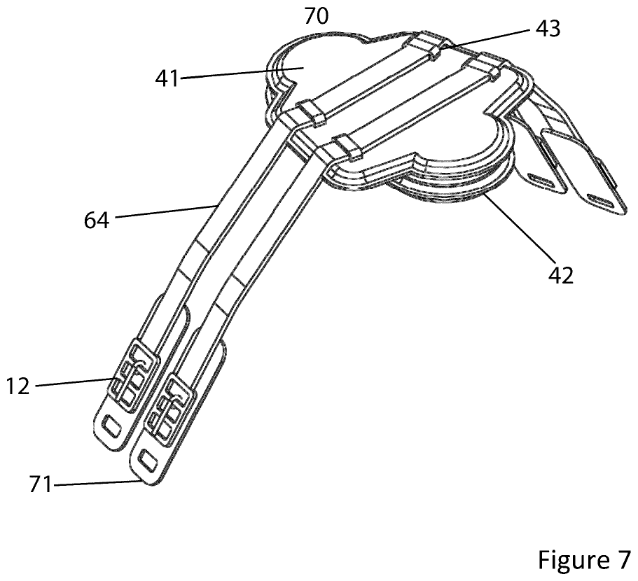

FIG. 7 is a view of the embodiment of FIG. 4 in its entirety orientated as viewed from under the horse looking up; and

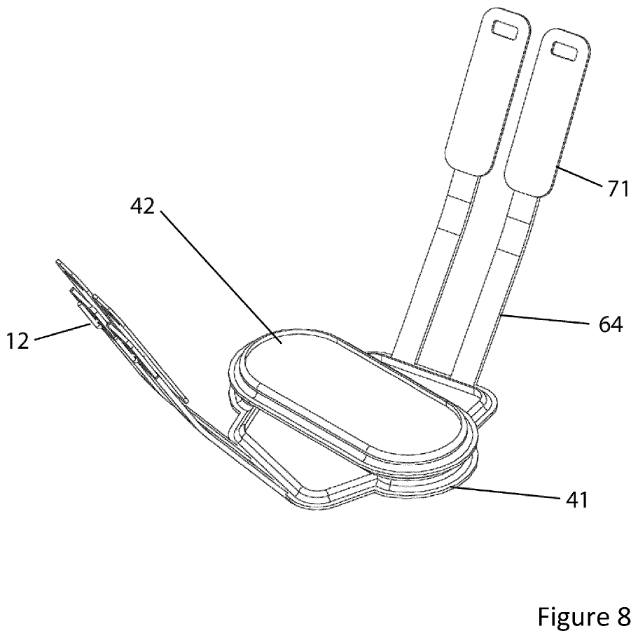

FIG. 8 is a view of the embodiment of FIG. 4 orientated as if it were on a horse with the back edge of the sternum plate nearest the viewer.

Accordingly, with reference to the accompanying figures, a preferred embodiment of a girth in accordance with the present invention includes a sternum plate which is made of two parts, a girth plate 41, typically including a resilient or reinforced plate, and a sternum pad 42.

The girth plate 41 includes a resilient or reinforced polymer plate 52 (FIG. 5) which will not flex under the pressures exerted by the girth straps when tightened on the horse. In preferred embodiments, the resilient or reinforced plate 52 is a plate which does not deflect or deform when a force of 20 Nm is applied to all the girth straps simultaneously perpendicular to the surface of the resilient or reinforced plate 52.

We have determined that polypropylene sheet having a thickness of about 5 mm and provided with welded ribs has a stiffness that is sufficient to withstand deformation or flexing by forces experienced in use of the saddle. Materials such as carbon fibre reinforced plastics sheet materials also provide lightweight solutions but are expensive when compared to polymeric materials.

Resilient plate 41 may include an outer cover 51, 54 of leather or a similarly performing material encasing the polymer plate 52 and a 10 mm foam padding layer 53. The foam padding layer 53 is positioned on the horse's side (proximal side) of the resilient plate 52, and is provided in the event of accidental collision between the plate and the animal in use and to provide additional shock absorption when directly under sternum pad 42.

The top cover 51 has slots 58 for keepers 43 to thread through. The keepers 43 position the girth straps 72 and ensure they do not move in relation to the plate in a longitudinal plan but do allow the straps 71 to move laterally to enable the rider to ensure the sternum pad 42 is always centrally located on the sternum of the horse before mounting.

In preferred embodiments, the sternum pad 42 is a foam pad 56 of approximately 25 mm thickness encased in leather or leather like material 57, 55. The upper part of the cover has four apertures or holes 59 to facilitate air flow to allow the foam to deform and recover as quickly as the horse can move its musculature. Without these holes the cover could act like a sealed air cell and not be shock absorbing or easily deformable. Conveniently, these holes also act as a lining up reference points in the construction of the sternum plate 40 and the resilient plate 41 is attached to sternum pad 42 by a box of stitching those corners are the four hole 59.

The foam that is used to pad the girth has sufficient qualities to provide for shock absorption when in use. We have determined that a foam with a net density of 100-120 kg/m³ and a compression resistance of 13-21 kPa provides excellent results. This specification of foam provides for a cushioning spring like reaction between the horse and the polymer plate 52. In total a spacing of 25 mm (56)+10 mm (53)=35 mm is provided between polymer plate 52 and the horse's rib cage 62.

The sternum plate sits directly on to the skin of the horse 63 and the majority of the force the girth exerts is transferred to the horse's sternum 22. There may be a small overlap onto rectus abdominus 31 and the ascending pectoral 21 muscles, but the majority of these muscle groups are sitting in free space 61 and can work at liberty.

With reference to FIG. 6, the angle of the girth straps 64 that is produced when coming off the side of resilient plate 52 (51-54) means that the pressures that are exerted on the sides of the horse's rib cage 62 are minimised because the force is applied to the horse's sides at such an oblique angle.

The girth tightness is kept more constant and even by the foam 53, 56 deforming and expanding as the rib cage/musculature expands and contracts when the horse is in movement. This facilitates the ability for the horse to use the pectoral muscles to maximum effect and increases stride length and the ability of the horse to “engage”. Engagement is when a horse steps under the body more with the hind legs and lifting its' back by recruiting rectus abdominus 31 and retract it fore limbs to a great extent recruiting ascending pectoral 21.

Girths of the present invention provide a more comfortable fit for the horse, leading to increases in the horse's rideability and a general willingness of the horse to perform the task that the rider asks of the horse.

1. A girth for a horse, the girth comprising girth straps (64) and a sternum plate (40) spacing and bridging the girth straps (64) such that, in use on a horse, the girth straps are substantially prevented by the sternum plate from contacting the horse in the region of the ascending pectoral (21) and rectus abdominus (31) muscles of the horse, wherein the sternum plate (40) comprises a girth plate (41) formed of a material which will not substantially flex or deform under pressures exerted by the girth straps when tightened, in use, on a horse.

2. A girth as claimed in claim 1 wherein the girth plate does not deflect or deform when a force of about 20 Nm is applied to the girth straps perpendicular to a surface of the girth plate (41).

3. A girth as claimed in claim 1 wherein the sternum plate (40) further comprises a sternum pad (42), wherein the sternum pad is positioned proximal to the horse, in use.

4. A girth as claimed in any preceding claim wherein the girth plate (41) is formed of a polymeric material or a formable or mouldable material, optionally a carbon fibre-reinforced plastic.

5. A girth as claimed in claim 4 wherein the girth plate (41) is formed of polypropylene having a thickness of from 3 mm to 8 mm, from 4 mm to 6 mm or about 5 mm.

6. A girth as claimed in claim 1 wherein the girth plate includes stiffening ribs.

7. A girth as claimed in claim 1 wherein the sternum plate (40) further comprises a proximal layer of foam padding, optionally a layer of foam padding having a thickness of from 5 mm to 18 mm, 8 mm to 14 mm, 9 mm to 12 mm or about 10 mm and optionally formed of a closed-cell foam.

8. A girth as claimed in claim 1 wherein the sternum plate includes an upper cover (51) and a lower cover (54), optionally wherein the upper and/or lower covers are formed of leather or a similarly-performing material.

9. A girth as claimed in claim 8 wherein at least one of the upper and/or lower covers includes perforations to permit air flow between the inside and outside of the sternum plate.

10. A girth as claimed in claim 1 wherein an upper surface of the sternum plate includes guides or keepers (43) to position the girth straps to prevent longitudinal movement with respect to the sternum plate.

11. A girth as claimed in claim 3, wherein the sternum pad (42) is formed of a foamed polymeric material, optionally a closed-cell foam.

12. A girth as claimed in claim 11 wherein the foam has a net density of 80-150 kg/m³, or 100-120 kg/m³.

13. A girth as claimed in claim 11 wherein the foam has a thickness of from 15 mm to 40 mm, 20 mm to 30 mm, or about 25 mm.

14. A girth as claimed in claim 3 wherein the sternum pad (42) further comprises an upper cover (55) and a lower cover (57), optionally wherein the upper and/or lower covers are formed of leather or a similarly-performing material.

15. A girth as claimed in claim 14 wherein at least one of the upper and/or lower covers includes perforations to permit air flow between the inside and outside of the sternum pad.

16. A girth as claimed in claim 11 wherein the foam has a compression resistance of 9 to 25 kPa, 11 to 24 kPa.

17. A girth as claimed in claim 1 wherein the sternum plate is shaped to follow the shape of the horse's rib cage as the circumference enlarges moving backwards from line A to line B as shown in FIGS. 2 and 3.
